(19) United States
(12) Patent Application Publication
(10) Pub. No.: US 2025/0143235 A1
(43) Pub. Date: May 8, 2025

(54) LAWN CARE APPARATUS

(71) Applicant: AI-WEEDER GMBH, Wien (AT)

(72) Inventor: Katharina NEUGEBAUER, Wien (AT)

(73) Assignee: AI-WEEDER GMBH, Wien (AT)

(21) Appl. No.: 18/838,140

(22) PCT Filed: Feb. 22, 2023
(86) PCT No.: PCT/IB2023/051602

§ 371 Date: Aug. 13, 2024

(30) Foreign Application Priority Data
Feb. 24, 2022 (AT) A 53/2022

(51) Int. Cl. A01G 20/30; A01D 43/00; A01D 101/00; A01M 21/02

(52) U.S. Cl. CPC A01G 20/30; A01D 43/00; A01M 21/02; A01D 2101/00

(57) ABSTRACT

A lawn care apparatus which can be mounted on a mobile unit and includes a digital camera, which can be oriented towards the lawn, and a control device and at least one tool which can be controlled by the control device and can be lowered to the lawn by a motor. The images from the digital camera are supplied to an algorithm implemented in the control device to perform object recognition so that upon recognition of an object, the control device lowers the tool in order for a work step to be performed on the object.

### CROSS-REFERENCE TO RELATED APPLICATIONS

The present application is a national phase application of PCT Application No. PCT/IB2023/051602, filed Feb. 22, 2023, entitled “LAWN CARE APPARATUS”, which claims the benefit of Austrian Patent Application No. A 53/2022, filed Feb. 24, 2022, each of which is incorporated by reference in its entirety.

### BACKGROUND OF THE INVENTION

### 1. Field of the Invention

The invention relates to a lawn care apparatus, which can be arranged on a mobile unit. The invention further relates to a robot lawn mower equipped with such an apparatus and having a mower deck and an autonomously operating traction drive.

### 2. Description of the Related Art

In order to improve the appearance of gardens adversely affected by weeds, fallen cones and needles from conifers, or fallen leaves from deciduous trees, to prevent damage to soil vegetation by shading and acidification of the soil by fallen cones and needles, and to prevent damage to the mower deck of a lawn mower by driving over cones on a lawn, weeds are either weeded manually or destroyed with chemical substances, cones, needles, and leaves are removed with rakes or collected by hand, and leaves are blown away by leaf blowers.

The disadvantage of manual procedures is the high workload. Disadvantages of chemical processes are the contamination of the soil, the damage to plants and animals, and the possible contamination of groundwater. Disadvantages of leaf blowers are the high noise level as well as the whirling up of dust and the fine dust pollution caused. Known robots and machines for weeding agricultural land have no function for collecting debris. Another disadvantage of the known robots and machines for weeding agricultural land is their high cost, their heavy weight and their size, which make them unsuitable for use in gardens.

### SUMMARY OF THE INVENTION

The aim of the invention is a robot that automatically, without manual assistance and without the use of chemical substances, removes weeds and detects and collects unwanted deposits such as cones, needles, leaves, or even waste. Furthermore, the invention aims to at least partially fulfilling the following requirements:
No release of chemicals during operation and emission-free operation (“Green Technology”).
No generation of noise and fine dust.
Protection of the mower deck of robot lawn mowers.
Gripping of objects of different sizes and shapes, such as cones and needles, with the same gripper.
Gripping of long objects, such as needles, regardless of their orientation.
Robust functioning.
Safe operation.
Compact design.
Low manufacturing costs.
When attached to a robot lawn mower, galvanic isolation from it or, alternatively, the use of its energy supply.

To solve this object, the invention provides a lawn care apparatus which can be mounted on a mobile unit and comprises a digital camera, which can be oriented towards the lawn, a control device and at least one tool, which can be controlled by the control device and can be lowered to the lawn by a motor, wherein the images from the digital camera are supplied to an algorithm implemented in the control device to perform object recognition so that upon recognition of an object, the control device lowers the tool in order for a work step to be performed on the object.

The at least one tool can be configured to remove weeds and/or to collect an object to be collected, such as cones, needles, leaves or waste, on the lawn area traveled over by the apparatus. For example, a separate tool for removing weeds and a separate tool for collecting objects, such as cones, needles, leaves or waste, can be provided, wherein the two tools can be controlled separately from one another in order to be lowered and to carry out their respective work steps. Alternatively, the apparatus may comprise only a single tool, which is designed either for removing weeds or for collecting objects, such as cones, needles, leaves or waste, on the lawn area traveled over by the apparatus.

If the object recognition implemented in the control device detects weeds in the camera images, the mobile unit or the robot lawn mower is stopped and then commanded to lower the tool and remove the weeds.

If the object recognition implemented in the control device detects an object to be collected in the camera images, such as cones, needles, leaves or waste, the mobile unit or the robot lawn mower is stopped and then commanded to lower the tool and collect the detected object.

In order to ensure optimal positioning so that the tool, in the lowered state, comes to lie exactly on or above the detected object, according to a preferred development of the invention it is provided that the tool is arranged in the lowered state in a detection range of the camera, wherein a constant image coordinate of the camera image is assigned to a contact point of the tool with the lawn. The position of the lowered tool and the detection range of the camera are matched in such a way that the contact point of the tool is located at a predefined location within the detection range. This makes it possible to assign a predefined image coordinate of the camera image to the contact point of the tool.

The positioning of the tool relative to the detected object is preferably carried out by means of the travel drive of the mobile unit, such as the robot lawn mower. This enables a simple design in which the tool itself only has to be mounted on the device so that it can be lowered and raised, and no further degrees of freedom need to be achieved. According to a preferred embodiment of the invention, the actuation of the mobile unit in such a way that the tool comes to lie on or above the detected object after being lowered is achieved in that the algorithm is configured to detect the center point of a detected object, wherein the control device is configured to output control commands to the mobile unit for approaching the object from a continuous determination of the distance between the constant image coordinate of the contact point of the tool and the center point of the detected object until the distance is below a predetermined limit value. The center point of the detected object can be detected, for example, as the center point of a rectangle or square surrounding the detected object.

The control device is preferably designed as a single-board computer. This ensures, on the one hand, a simple and cost-effective structure and, on the other hand, sufficient computing capacity, which enables image-based object recognition. In this context, a single-board computer is to be understood as a computer system in which all the electronic components necessary for operation are combined on a single printed circuit board.

In order to enable reliable object recognition, which requires a limited computing capacity and therefore causes low energy consumption, the object recognition is preferably carried out by means of a deep learning method by means of a convolutional neural network implemented in the control device, in particular on the single-board computer. The weights and bias values of the neurons of the network are preferably trained by means of transfer learning on the basis of more than 2000 images of the desired object classes such as weeds, cones or needles. For each examined image from the digital camera, the convolutional neural network outputs a matrix that contains an index of the object class, the image coordinates of the surrounding rectangle, and the detection probability of the object class for each object detected.

If the detection probability of an object exceeds a threshold value of, for example, 50%, the object is classified as detected, and any driving process of the mobile unit is stopped and the commanding process is initiated or, if it is already in progress, continued. That detected object, which is closest to the robot, is selected for the commanding process for the following weeding or gripping process. The center of its enclosing rectangle forms the output coordinate for the command operation.

As mentioned above, the lowerable tool may be configured as a weeding device for weeding weeds. The weeding device may comprise, for example, a rotating blade or a rotating cutting thread. As soon as weeds are detected by the object recognition in the detection range of the camera, the control device causes the geometric contact point of the weeding device with the ground to be located above the detected weeds. The arm with the weeding device is extended or lowered, and the weeding device is activated, which separates the weed from its root. Thereafter, the weeding device is stopped and retracted again, and the area is traveled further. Although a large part of the root remains in the soil, the further growth and thus the propagation of the weed are stopped. After a number of such separation processes, the root does not sprout again and rots without further intervention in the soil.

As already mentioned, the lowerable tool can also be configured as a gripper for gripping and collecting objects lying around, such as cones, needles, leaves or waste. An advantageous embodiment of the gripper provides that the gripper is arranged on an arm, which can be pivoted about a substantially horizontal axis. The gripper can thus be easily lowered and raised again.

In order to enable the gripper to operate in such a way that objects of different shapes can be gripped securely, it is preferably provided that the gripper has at least two, in particular three, parallel gripping elements which are guided so as to be movable relative towards and away from each other. In this case, the guidance of the gripping elements is preferably designed in such a way that the gripping elements remain in their parallel orientation during the gripping process, so that, in contrast to grippers with gripping elements that can be pivoted relative to one another, i.e. can be changed in angle, e.g. can be moved in the manner of pliers, no vertical forces are introduced into the object to be gripped.

The contact surfaces of the gripping elements can preferably be anodized to increase the frictional force.

If the object recognition implemented in the control device, in particular in the single-board computer, detects an object to be collected, such as cones, needles, leaves or waste, the mobile unit is stopped and commanded such that the geometric center of the lowered gripper is located above the object. After that, the arm with the open gripper can be lowered and the gripper closed, so that the object is gripped. The arm with the gripper and the gripped object can then be raised.

For the temporary storage of collected objects, the device according to a preferred development further comprises a collecting container, which is arranged below a discharge position of the gripper. As soon as the gripper together with the gripped object has been lifted above the collecting container, the subsequent opening of the gripper causes the object to fall off into the collecting container.

If only the function of weed removal is required, the arm with the gripper is omitted. If only the collecting function is required, the arm with the weeding device is omitted. In an alternative embodiment, the weeding device is not attached to a separate arm, but is attached to the arm of the gripper or to a leg of the gripper.

Thanks to the invention, a robotic weed-removing and debris-collecting device is possible, which has a number of advantages:

No release of chemicals during operation and emission-free operation (“Green Technology”): Weed eradication takes place purely mechanically, with all drives powered by electric motors.
No generation of noise and fine dust: The principle of action is based neither on suction nor on blowing action, and thus does not produce fast-flowing fluids at any point, which cause noise or fine dust emission.
Protection of the mower deck of robot lawn mowers: If the device is placed on a robot lawn mower, the image area of the camera is designed to cover the mowing strip in front of the robot lawn mower, and the robot detects and removes cones lying on the lawn before the robot lawn mower passes over this area.
Gripping of objects of different sizes and shapes, such as cones and needles, with the same gripper: The design of the gripper with radially closing gripping elements or legs leads to a compensation of the gripping forces with one another. In contrast to grippers designed according to the principle of hinged pliers, gripping forces do not have to be compensated by friction. Thus, the gripping function is not limited by friction angles. In the described embodiment of the gripper with radially closing legs, only the weight of the gripped object is absorbed by friction. The gripper grips large objects such as cones and small objects such as needles in the same radial manner.
Gripping of long objects, such as needles, regardless of their orientation: If the long object to be gripped is placed between the radially closing gripping elements or legs of the gripper in its open position, a closing of the gripper leads to an alignment of the long object between a gripping element and a pair of the remaining two gripping elements, and finally to a gripping of the object. The gripper thus grips long objects, such as needles, regardless of the direction in which they lie.
Robust functioning: If the object to be gripped is placed between the radially closing gripping elements of the gripper in its open position, a closing of the gripper leads to a centering of a round object. The gripping function is thus also fulfilled in the event of an inaccurate positioning of the gripper above the object to be gripped.
Safe operation: the continuously executed object recognition algorithms detect the weeds and/or the objects to be gripped. The weeding process and the gripping process can be stopped immediately as soon as unknown elements appear in the image area. Further protection can be achieved by attaching commercially available pyroelectric proximity sensors to the robot, which interrupt the weeding process and the gripping process when approaching living beings.
Compact design: If the apparatus is placed on a robot lawn mower, it does not protrude beyond the robot lawn mower on its circumference, or protrudes only insignificantly, when the arms are retracted. The enveloping radius of the open gripper projects beyond that of the maximum gripping radius only by the radial extension of the gripping element.
Low manufacturing costs: The possibility of placing on a user's existing or planned to purchase robot lawn mower saves the manufacturing costs for a chassis. In an embodiment with an electrical connection to this robot lawn mower, its energy storage (accumulator) and its charging infrastructure can also be used by the robot and their execution on the robot can be saved. Due to the coupling of the movements of the gripping elements in the gripper and the described trajectory of the weeding device, the described kinematics leads to a minimum of motorised axes of movement and the associated manufacturing costs. The trajectory of the weeding device is preferably arranged at a flat angle to the horizontal, so that only the frictional moment has to be overcome for the horizontal component of the movement. The weight only needs to be overcome for the vertical component of the movement. This allows a compact and cost-effective actuator with low torque for the arm of the weeding device.
When attached to a robot lawn mower, galvanically isolated operation from it is possible. In this embodiment, the robot is commanded via WLAN. No physical intervention inside the interior of the robot lawn mower is then necessary. A possible associated depreciation of the robot lawn mower and a possible loss of warranty are thus prevented.

### BRIEF DESCRIPTION OF THE DRAWINGS

Further features and advantages of the invention emerge from the following description of a preferred exemplary embodiment of the invention, which does not limit the scope of protection, with reference to the attached drawings.

FIGS. 1 and 2 show perspective views of the robot,

FIG. 3 shows a perspective view of the robot with the arm of the weeding device folded out,

FIG. 4 shows a perspective view of the robot with the arm of the gripper folded out,

FIG. 5 shows a side view of the robot,

FIG. 6 shows a perspective view of the weeding device,

FIG. 7 shows a perspective view of the gripper in the open state,

FIG. 8 shows a perspective view of the gripper in the closed state,

FIG. 9 shows a detailed perspective view of the gripper in the open state,

FIGS. 10 and 11 show the add-on module for lawn mowers for the embodiment as a robot for weed removal as a retrofit for existing robot lawn mowers,

FIG. 12 shows a robot lawn mower retrofitted with the add-on module, and

FIG. 13 shows the latter being retrofitted with the add-on module with the extended arm of the weeding device.

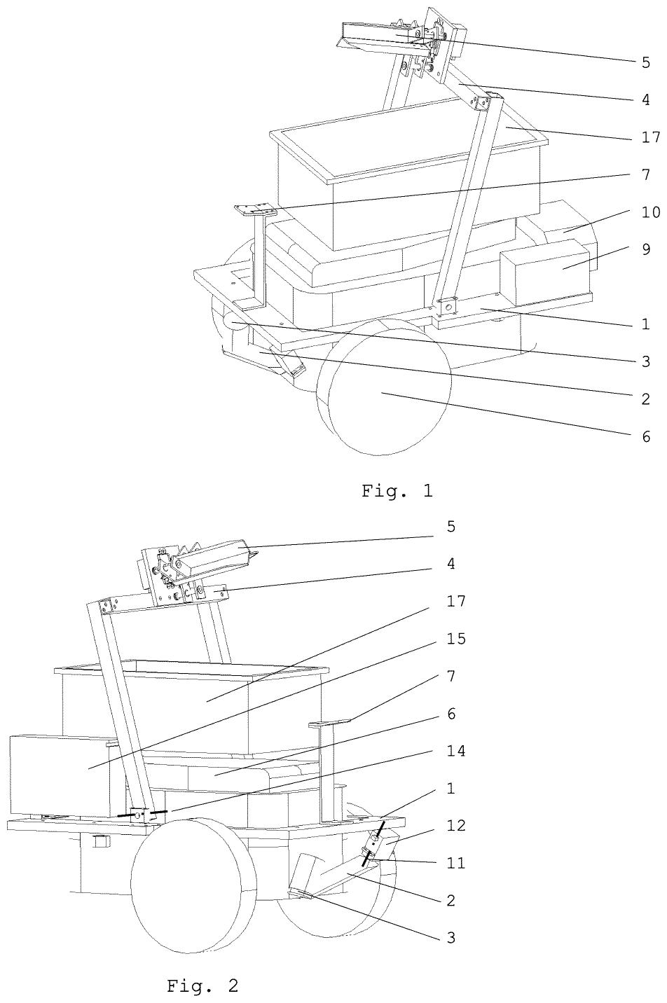

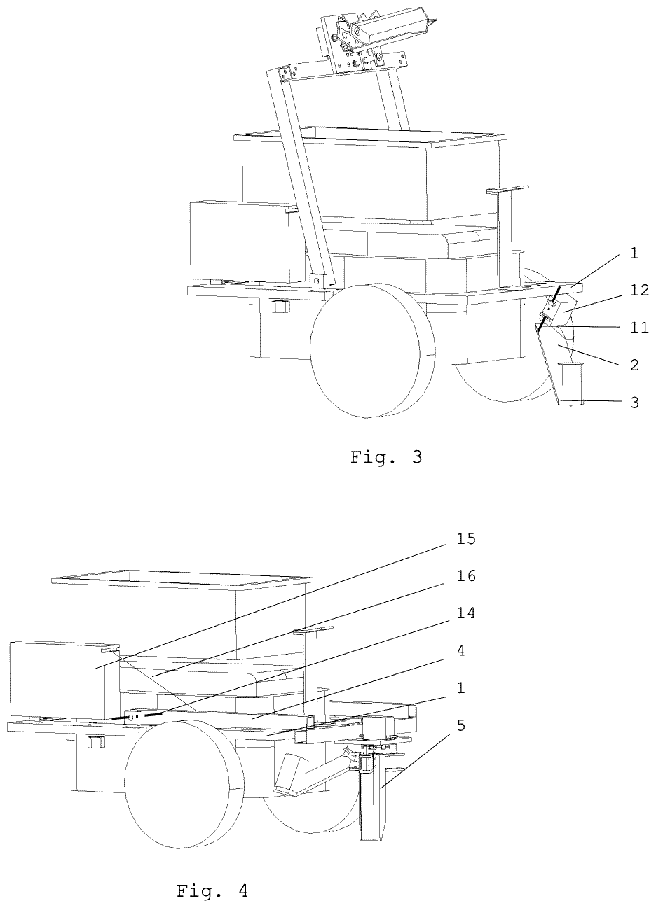

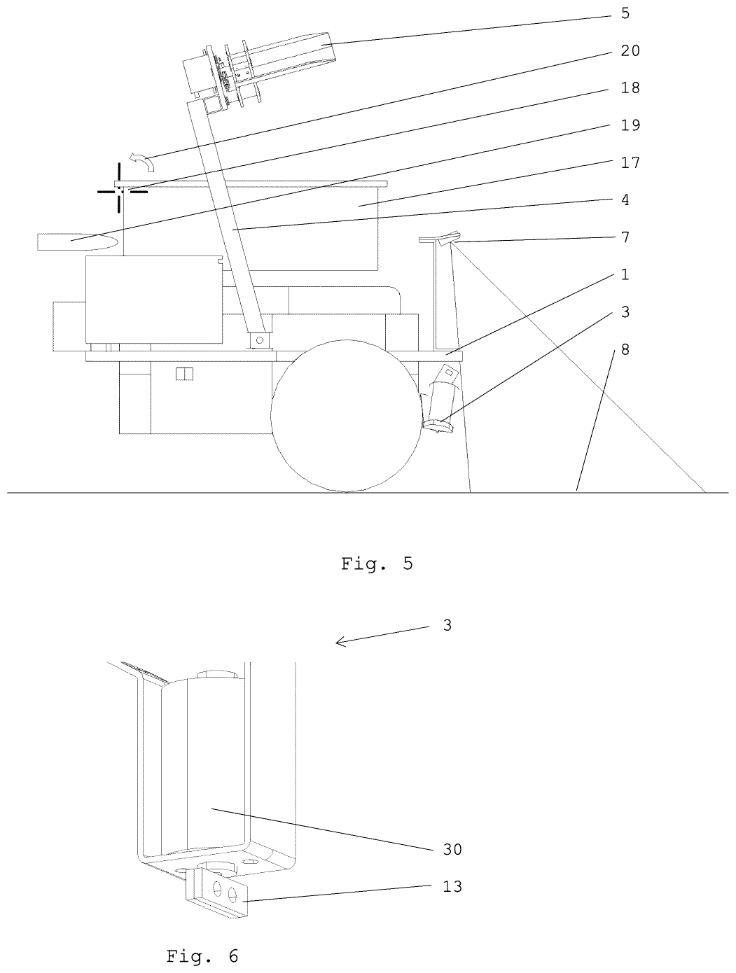

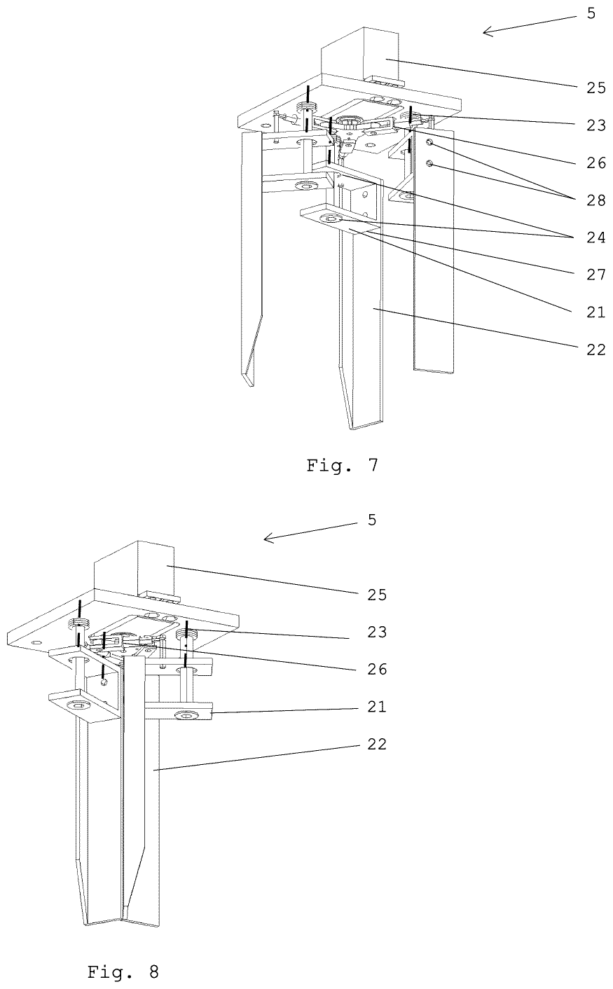

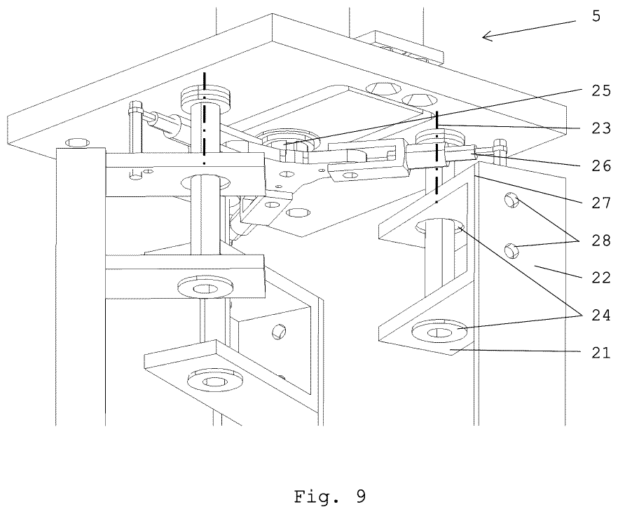

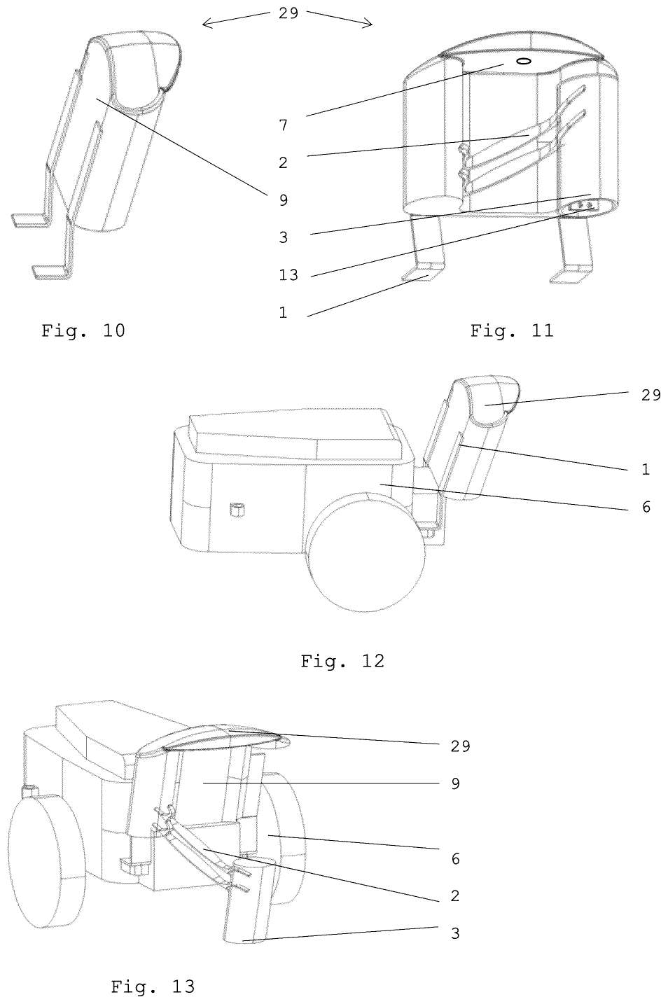

### DETAILED DESCRIPTION

The robot consists of a base frame 1, an arm 2, which can be extended therefrom by a motor about an inclined axis, with a weeding device 3, and a further arm 4, which can be moved by a motor, with a gripper 5.

The base frame 1 is mounted on a robot lawn mower 6. In an alternative embodiment, the base frame is designed with its own chassis as a mobile platform.

The camera 7 captures images of the area 8 in the direction of travel in front of the robot, which are continuously evaluated by means of object recognition with a frequency of at least 3 Hz.

The camera 7 is connected to the base frame 1, to which the arm 2 of the weeding device 3 is also connected in a hinged manner. The geometric contact point of the extended weeding device with the ground is assigned a constant image coordinate of the camera image, which forms the target coordinate for the commanding process for weeding. The arm 4 of the gripper 5 is also connected in a hinged manner to the base frame 1. A constant image coordinate of the camera image, which forms the target coordinate for the gripping command operation, is also assigned to the geometric center of the lowered gripper.

For commanding the robot to the target coordinate, the output coordinate continuously determined by the object recognition is used as a feedback signal for controlling the robot movement. Depending on the distance of the output coordinate from the target coordinate, a drive torque is applied to the left and right wheel drives of the robot lawn mower 6, in the same direction to reduce the distance from the output coordinate to the target coordinate in the direction of travel of the robot, in the opposite direction to reduce the distance from the output coordinate to the target coordinate in a direction normal to the direction of travel of the robot. If the initial coordinate is within a tolerance radius of about 5 mm around the target coordinate, the target is considered reached, the corresponding arm is lowered for weeding or gripping and the weeding or gripping process is carried out.

If no further objects are detected in the camera image, the previously stopped driving process of the robot lawn mower 6, and thus its mowing, its searching for the charging station, or its turning, is continued.

The single-board computer is connected to the Internet by means of WLAN or, in an alternative embodiment, by means of a mobile data connection such as, for example, LTE. The user operates the robot primarily with a browser or an app on the mobile phone, tablet or PC. The data exchange with the robot lawn mower, including the described command of its wheel drives for controlling the target coordinate, is also carried out via the WLAN.

In an alternative embodiment, there is a cable connection to the robot lawn mower for data exchange via a data line and/or for supplying power to the robot by the accumulator of the robot lawn mower. If, in such an embodiment, the accumulator of the robot lawn mower is also used by the robot, the accumulator 10 for the autonomous power supply of the robot is omitted.

To actuate the drives for the two arms 2 and 4 and the drives of the weeding device 3 and the gripper 5, as well as, if the base frame is not mounted on a robot lawn mower in an alternative embodiment, the chassis, there is motor control electronics mounted in the same housing 9, which, like the single-board computer, is powered by an accumulator 10 on the robot.

The arm 2, at the end of which a weeding device 3 is located, is attached to the base frame 1. This arm is rotatable about an inclined axis 11 connected to an electric drive 12. The position of the axis 11 is selected so that, when the arm 2 is extended, the weeding device 3 moves away from the base frame 1 and it is lowered to the ground with the same movement. The lowering takes place at a point which is captured by the image area 8 of the camera 7.

The weeding device 3 consists of a rotatable blade 13 driven by the electric motor 30. In an alternative embodiment, the weeding device is provided with a cutting thread instead of the blade 13.

A further arm 4 is attached to the base frame 1. This is mounted so as to be rotatable on both sides about the axis 14. In an alternative embodiment, this arm 4 is designed to be rotatable about the axis 14 in a manner supported on one side. A gripper 5 is attached to this arm 4. The rotation is actuated by an electric drive 15 by means of a traction cable 16. The position of the axis 14 is selected so that a rotation of the arm 4 moves the gripper 5 from a position above the base frame 1 into a position in front of the robot, which is captured by the image area 8 of the camera 7.

A collecting container 17 is attached to the base frame 1 below the upper position of the gripper 5. Falling objects released by the gripper fall into this collecting container 17.

In another embodiment, the collecting container 17 is connected in an articulated manner to the base frame 1 on an axis of rotation 18 running horizontally near the upper edge of the collecting container and at right angles to the direction of travel. An emptying station, which is connected to the charging station or is designed independently of the charging station, is provided with a link 19, which is arranged below the recognof this axis of rotation. Due to the collision with the link 19, moving into the emptying station or into the charging station against the link 19 causes the collecting container 17 to rotate in the direction marked by the arrow 20, thereby emptying the contents of the collecting container 17. The arm 4 with the gripper 5 is folded away from the movement range of the collecting container during such a process, so that no collision occurs.

The gripper 5 consists of three identical, radially interacting legs, each consisting of a connecting piece 21 and a gripping element 22. The legs are each arranged rotatably about an axis of rotation 23 offset with respect to the gripping elements 22 by means of pairs of ball bearings 24. Rotation of the legs about the axis of rotation 23 causes the gripping elements 22 to move along a circular path. The axes of rotation of the three legs are arranged at approximately the same distance from one another on a common pitch circle, so that a movement of their gripping elements 22 resulting from the rotation of the legs causes the three gripping elements 22 to open or close with respect to one another. An electric drive 25 is arranged in the center of the pitch circle.

The transmission of the rotational movement between the electric drive 25 and the three legs takes place by means of push rods 26. In the embodiment shown, the push rods 26 are designed in two portions. The portion of the push rod, which is rotatably connected to the drive, is provided with an internal thread, and the portion of the push rod, which is rotatably connected to the leg, is provided with an external thread. A rotation of the push rod portions relative to one another causes a change in length of the push rod and thus allows an adjustment of the contact point of the three legs in the closed state of the gripper. In an alternative embodiment, the transmission of the rotational movement between the drive and the three legs is transmitted by a gear in which the legs are provided with gears or gear segments which engage in a central sun gear between the gears of the legs or in a ring gear which encloses the gears of the legs. In this embodiment, the adjustment of the contact point between the legs in the closed state of the gripper is carried out by assembling the gears in the corresponding angular position.

In the embodiment shown, the drive is arranged centrally. In an alternative embodiment, one of the three legs is directly driven by the drive. In this alternative embodiment, the transmission of the rotational movement between the directly driven leg and the two other legs takes place by means of the described push rods or the described gear transmissions.

The legs are designed in two portions. The connecting pieces 21 of the legs, which are rotatably connected to the push rods 26, are provided with inner mounting faces 27, to each of which a gripping element 22 is clamped by means of a screw connection in the bore 28. Shifting the gripping elements 22 along the inner mounting faces 27 allows the parallelism of the gripping elements 22 of the three legs to be adjusted in order to achieve precise closing along a contact line. The gripping elements 22 have an L-shaped cross section in order to achieve high bending stiffness and a position of their thrust center in the direction of the clamping force, and thus preventing their rotation when the gripping force is applied. The gripping elements 22 are anodized in order to achieve a high coefficient of friction between the gripping element and the object to be gripped, as well as high wear resistance.

In one embodiment as a weed removal robot, an add-on module 29 is attached to an existing robot lawn mower 6. In this add-on module 29, the camera 7 and an arm 2 for lowering the weeding device 3 are provided. The single-board computer and the motor control electronics are housed in the housing 9. The add-on module is connected to the frame 1, which is much more compact in this embodiment, to the robot lawn mower 6.

1-19. (canceled)

20. A lawn care apparatus configured to be mounted on a mobile unit, comprising:
a digital camera configured to be oriented towards a lawn;
a control device; and
at least one tool configured to be controlled by the control device and configured to be lowered to the lawn by a motor;
wherein images from the digital camera are supplied to an algorithm implemented in the control device to perform object recognition so that, upon recognition of an object, the control device lowers the tool in order for a work step to be performed on the object;
wherein the tool is arranged in a lowered state in a detection range of the camera; and
wherein a constant image coordinate of the camera image is assigned to a contact point of the tool with the lawn.

21. The lawn care apparatus according to claim 20, wherein:
the algorithm is configured to detect the center point of a detected object; and
the control device is configured to output control commands to the mobile unit for approaching the object from a continuous determination of the distance between the constant image coordinate of the contact point of the tool and the center point of the detected object until the distance is below a predetermined limit value.

22. The lawn care apparatus according to claim 20, wherein the control device is configured as a single-board computer.

23. The lawn care apparatus according to claim 20, wherein the tool is configured as a weeding device.

24. The lawn care apparatus according to claim 23, wherein the weeding device comprises one or more rotating blades or a rotating cutting thread.

25. The lawn care apparatus according to claim 23, wherein the weeding device is arranged on an arm, the arm configured to be pivoted about an axis extending obliquely from a vertical up position to a substantially horizontal position.

26. The lawn care apparatus according to claim 20, wherein the tool is configured as a gripper.

27. The lawn care apparatus according to claim 26, wherein the gripper is arranged on an arm, the arm configured to be pivoted about a substantially horizontal axis.

28. The lawn care apparatus according to claim 26, wherein the gripper comprises at least two parallel gripping elements, the at least two parallel gripping elements being guided to be movable relative towards and away from each other.

29. The lawn care apparatus according to claim 28, wherein:
a movement of the gripping elements runs along a respective circular arc; and
pivot axes forming a respective center point of the respective circular arcs are arranged evenly along a circle and parallel to one another.

30. The lawn care apparatus according to claim 29, wherein a drive member is provided, which is rotatably driven by a motor about the axis of the circle and which is drivingly connected to each gripping element in order to drive said gripping element along the respective circular arc.

31. The lawn care apparatus according to claim 28, wherein contact surfaces of the gripping elements are anodised.

32. The lawn care apparatus according to claim 26, further comprising a collecting container arranged below a discharge position of the gripper.

33. The lawn care apparatus according to claim 32, wherein the collecting container is hinged to an axis of rotation running horizontally in a region of an upper edge of the collecting container and at right angles to a direction of travel, the collecting container configured to be tilted and emptied by approaching a link positioned below the axis of rotation.

34. The lawn care apparatus according to claim 20, wherein an electric motor drive is provided for lowering and lifting the at least one tool.

35. The lawn care apparatus according to claim 20, wherein the apparatus is an integral component on a robot lawn mower.

36. The lawn care apparatus according to claim 20, wherein the apparatus is a retrofit module to be mounted on a robot lawn mower.

37. A robot lawn mower, comprising:
a mower having an autonomously operating travel drive; and
a lawn care apparatus mounted on the mower, the lawn care apparatus including:
a digital camera configured to be oriented towards a lawn;
a control device; and
at least one tool configured to be controlled by the control device and configured to be lowered to the lawn by a motor;
wherein images from the digital camera are supplied to an algorithm implemented in the control device to perform object recognition so that, upon recognition of an object, the control device lowers the tool in order for a work step to be performed on the object;
wherein the tool is arranged in a lowered state in a detection range of the camera; and
wherein a constant image coordinate of the camera image is assigned to a contact point of the tool with the lawn.

38. The robot lawn mower according to claim 37, wherein the digital camera is oriented towards the lawn lying in front of the mower in a direction of travel.
